(19) United States
(12) Patent Application Publication
(10) Pub. No.: US 2009/0180783 A1
(43) Pub. Date: Jul. 16, 2009

(54) METHOD, NETWORK, APPARATUS AND COMPUTER PROGRAM FOR USING LEAKY COUNTERS IN CLOCK AND DATA RECOVERY CIRCUITS

(75) Inventors: Shuo Huang, Novato, CA (US); Paul E. O'Connor, Grass Valley, CA (US)

Correspondence Address: FITZPATRICK CELLA HARPER & SCINTO, 30 ROCKEFELLER PLAZA, NEW YORK, NY, 10112, US

(73) Assignee: Tellabs Petaluma, Inc., Naperville, IL (US)

(21) Appl. No.: 11/972,775

(22) Filed: Jan. 11, 2008

(51) Int. Cl. H04B 10/00

(52) U.S. Cl. 398/155

(57) ABSTRACT

A method for performing CDR on a digital transmission, and an apparatus, system, and computer program that operate in accordance with the method. The method includes oversampling the digital transmission into oversampled data, detecting edges between adjacent bits of the oversampled data, counting the edges, and selecting at least one sample of the oversampled data. The sample is selected by a decision logic, which is at least partially controlled by counts of the edges.

### BACKGROUND

1. Field

Example aspects of the present invention generally relate to the transmission of data in a communications network, and more particularly to performing clock and data recovery on a digital transmission.

2. Related Art

In the telecommunications industry, network service providers transmit multimedia information, including voice, video, and data information, to users of their networks via a local loop distribution network, one example of which is a passive optical network (PON). A PON can be classified according to the location where optical-electrical conversion of signals occurs. For instance, one PON classification is a fiber-to-the-node (FTTN) network, in which optical-to-electrical conversion typically occurs at nodes local to a number of subscribers, and the subscriber equipment connects to the nodes using traditional coaxial or twisted-pair electrical wiring. Similarly, in a fiber-to-the-premises (FTTP) network, which is another classification of PON, conversion typically occurs at a subscriber's premises. Other examples of PONs include fiber-to-the-business (FTTB), fiber-to-the-curb (FTTC) and fiber-to-the-home (FTTH) networks. These types of networks are herein referred to generally as “FTTx networks.”

A typical FTTx PON includes one or more optical line terminals (OLTs), which are located at a service provider's central office and can include one or more PON cards. Various example configurations of an FTTx network are shown in FIG. 1. In a typical FTTP network, each OLT is communicatively coupled to one or more optical network terminals (ONTs), each of which in turn is communicatively coupled to customer premises equipment (CPE) used by end users (e.g., customers, subscribers, and the like) of the network services (e.g., voice services, video services, and/or data services) provided by the service provider. In a typical FTTC network, each OLT is communicatively coupled to optical network units (ONUs) via an optical distribution network (ODN). The ONUs are then communicatively coupled to CPE through network terminals (NTs) such as, for example, digital subscriber line (DSL) modems, asynchronous DSL (ASDL) modems, very high speed DSL (VDSL) modems, and/or the like. In a typical FTTN network, each OLT is communicatively coupled to remote digital terminals (RDTs) or other remote terminals (RTs). CPE are then communicatively coupled to RDTs through NTs. Thus, depending on the specific FTTx configuration, the user node may be an ONT, an optical network unit ONU, and/or a remote digital terminal RDT.

### SUMMARY

According to an example aspect of the invention, a method is provided; a system, apparatus, and computer program product that operate in accordance with the method also are provided. The method performs clock and data recovery (CDR) on a digital transmission, and includes oversampling the digital transmission into oversampled data, detecting edges between adjacent bits of the oversampled data, counting the edges, and selecting at least one sample of the oversampled data. Additionally the sample(s) is selected by a decision logic and the decision logic is at least partially controlled by counts of the edges.

Further features and advantages, as well as the structure and operation, of various example embodiments of the present invention are described in detail below with reference to the accompanying drawings.

### BRIEF DESCRIPTION OF THE DRAWINGS

The features and advantages of the example embodiments of the invention presented herein will become more apparent from the detailed description set forth below when taken in conjunction with the drawings in which like reference numbers indicate identical or functionally similar elements.

FIG. 1 is a network diagram illustrating example configurations of a PON.

FIG. 2 shows a flow diagram of a method in accordance with an example embodiment of the invention.

FIG. 3 is a circuit diagram of an example clock and data recovery circuit operable in accordance with an example aspect of the invention.

FIG. 4 is a circuit diagram of an example sampling point decision circuit operable in accordance with an example aspect of the invention.

FIG. 5 is a diagram illustrating an example leaky counter.

FIG. 6 is a truth table illustrating an aspect of the operation of an example leaky counter.

FIG. 7 is a truth table illustrating another aspect of the operation of an example leaky counter.

FIG. 8 is a logical diagram of a control module, which may be suitable for practicing one or more example embodiments of the invention.

FIG. 9 is an example data processing architecture.

### DETAILED DESCRIPTION

The following description and example embodiments are described in the context of a PON having ONTs as user nodes. However, this context is chosen only for the sake of simplicity; the invention is not limited for use solely with ONTs, but can also be used in conjunction with other user nodes such as, for example, ONUs, RDTs, any other suitable types of nodes operable within a communication network, or any combination thereof. Moreover, upon reading of the following description it will be apparent to one with skill in the relevant art how to practice alternative example embodiments within communication networks other than PONs.

In a typical PON, downstream digital communications, e.g., data transmissions transmitted from an OLT to one or more ONTs, are transmitted over a single fiber optic channel operating in a continuous mode. Included with the downstream communications is a data stream, which contains timing information generated by the OLT that enables a receiving device, e.g., an ONT, to recover a clock signal, hereinafter referred to as a “downstream clock.” In order for a communication to be properly decoded by an ONT, the ONT first must lock to the downstream clock. Once the clock has been locked, the ONT can then use the clock to determine the proper alignment of bits within the bitstream of the communication. This two-step procedure is generally referred to as clock and data recovery (CDR). Devices such as, for example, ONTs typically perform CDR on downstream communications, i.e., continuous mode communications, through the use of phase-locked loop (PLL) circuitry and the like.

Similarly, upstream digital communications, i.e., communications transmitted from one or more ONTs to an OLT, are typically transmitted with an upstream transmit clock generated by ONT. This clock is at the same frequency as the downstream clock; the ONT generates the upstream clock based off of the downstream clock signal, which has been recovered by the ONT through CDR of downstream communications. The OLT then performs its own CDR on upstream communications transmitted from the various ONTs in the PON.

In a typical PON, however, upstream communications are transmitted over a channel operating in a burst mode; unlike downstream communications, where a single ONT sends communications to multiple ONTs, for upstream communications multiple ONTs must send communications to a single OLT. Since simultaneous upstream transmissions from multiple ONTs can interfere with one another, preventing proper data transmission, each ONT can only send a communication during an allocated time. Thus, upstream transmissions occur in bursts, where each burst can originate from a different ONT. In order for an individual ONT to transmit upstream at its proper allocated time, the clock signal sent by the OLT in the downstream transmission (and recovered by the ONT during CDR of the downstream transmission) is used by the ONT to determine when its upstream transmission begins. Although each ONT generates its upstream clock signal based upon the downstream clock signal sent by the OLT, because the ONTs in a typical PON are located at various distances from the OLT, there can be a phase difference between the clock signals received from the various ONTs in the PON; the physical signal, e.g., optical and/or electrical, in which the communication is encoded travels at a finite speed, requires varying lengths of time to travel different distances. Thus, to receive and recover upstream communications from ONTs, the OLT must lock on to a different clock signal for each burst in order to decode discrete communications received from each ONT.

Procedures for performing CDR on upstream burst communications vary. PLL circuits, which typically are used for continuous downstream transmission, may have limited effectiveness when used for upstream CDR applications because the time required for a PLL circuit to lock onto to a clock signal can be much longer than length of time occupied by an upstream burst communication; thus, PLLs may not be suitable for CDR on upstream communications sent at high data transmission rates. Such communications can occur in a high-speed network such as, for example, a broadband PON (BPON), an Ethernet PON (EPON), a gigabit PON (GPON), a wavelength division multiplexed PON (WDM-PON), and the like. Upstream data transmission rates in networks such as these may include, for example, 125 Mb/s, 622 Mb/s, 1.25 Gb/s, as well as other data rates. Therefore, other procedures and/or implementations of CDR can be used to decode upstream communications transmitted at high data rates.

In addition to the complications of performing CDR on upstream communications, as described above, undesirable signal variations, i.e., “jitter,” can further complicate the CDR of upstream data transmissions. Typically, jitter characteristics, e.g., undesired changes in phase, amplitude, frequency, and the like, are introduced into a signal transmitted over a distance such as, for example, signals transmitted in a PON. Thus, a downstream clock recovered at an ONT can have jitters. Those with skill in the art will recognize that PLL-based CDR circuits are anti-jitter circuits. These circuits, however, generally reduce only high-frequency jitter components; low-frequency jitter components may not be reduced by these circuits, and a downstream clock recovered by a PLL-based CDR circuit at an ONT may not be a high fidelity signal. Therefore, because an ONT uses the recovered downstream clock to send upstream transmissions, the CDR procedure performed on upstream transmissions may have to tolerate significant low-frequency jitter. PLL-based CDR at an OLT may not be able to tolerate this amount of jitter, and other procedures and/or implementations of CDR can be used.

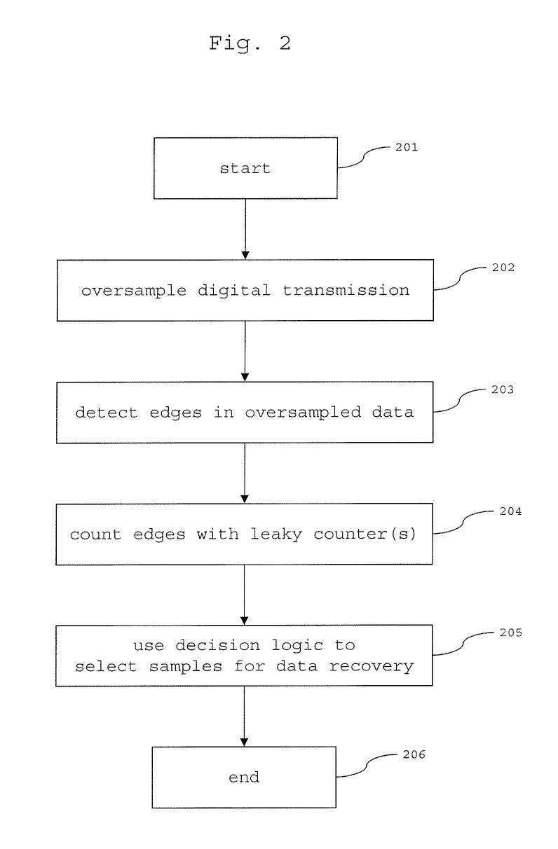

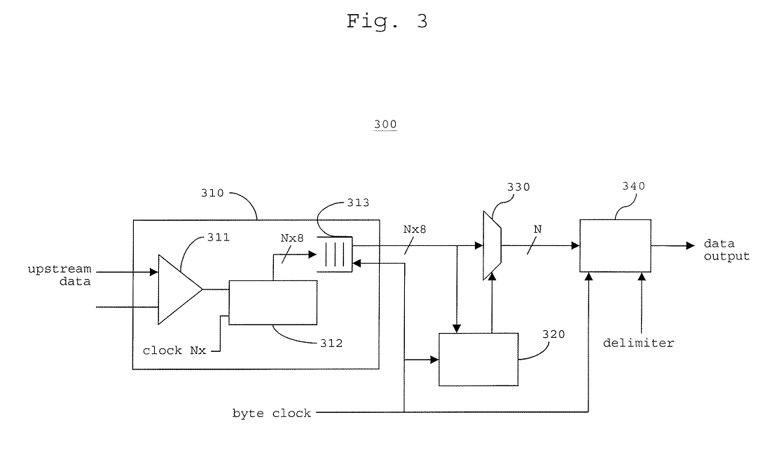

FIG. 2 shows a flow diagram of a method of performing CDR on a digital data transmission, according to an example embodiment of the invention. The method illustrated by FIG. 2 can be used for performing CDR for applications where jitter tolerance may be required such as, for example, recovering data from an upstream data transmission in a PON. At block 201, the method is commenced. At block 202, the bitstream comprising the data transmission is oversampled, i.e., one or more samples are taken of each incoming bit. Oversampling can be performed by, for example, oversampler 311 (described below in connection with FIG. 3) or any other suitable sampler. The data transmission rate multiplied by the number of samples made per incoming bit is the oversampling ratio, which is referred to herein as “N.” Each consecutive N samples made per incoming bit is referred to herein as a “sample set.”

As described above, the upstream clock signal transmitted by ONTs in a PON can be subject to jitter and/or phase differences. Therefore, oversampling at block 202 may occur without a high fidelity clock (e.g., a clock transmitted by an ONT and recovered by an OLT), and the N samples made per upstream input bit may not exactly coincide with each incoming bit, i.e., the bit alignment may be unknown. Rather, each set of N samples may be made such that some samples of a set occur during one incoming bit and the other samples occur during the input of the following bit. As an example, consider an upstream data rate of 1.25 Gb/s and an oversampling ratio of five. In this example, the period of each upstream bit is 0.8 ns, a sample of the upstream data is taken every 0.16 ns, and a new byte is received at an OLT every 6.4 ns.

If a high fidelity upstream clock signal is not available, then it can be difficult for a CDR circuit to determine where one byte ends and the following byte begins, i.e., when the proper 6.4 ns have passed. However, the OLT can correctly determine the data transmission rate because, as described above, when communicating upstream in a PON, an ONT uses a recovered downstream clock to transmit its upstream data. Thus, an OLT can use its own local clock to determine the incoming data transmission rate and oversample the incoming data accordingly.

In an example embodiment of the invention, the oversampled data can be arranged into N parallel sample bytes. Each sample byte can be comprised of eight bits, where each bit can correspond to an individual sample number. For example, if upstream data is oversampled at an oversampling ratio of five (N=5), then there are five samples per input bit and 40 samples per input byte (as described above, the location of transitions between input bytes can be unknown). These 40 samples can be arranged into five parallel sample bytes, where the first sample byte can be comprised of every fifth, i.e. Nth, sample beginning with first input bit, the second sample byte can be comprised of every fifth sample starting from the second input bit, and so forth.

At block 203, edges, i.e., transitions from “0” to “1” or vice versa, are detected in the oversampled data. Because the unrecovered upstream transmission is digital, edges in the oversampled data can indicate the location of individual bits in the upstream transmission. Edges can be detected by, for example, comparing the values of adjacent bits in serial (unarranged) oversampled data, i.e., if they differ, then an edge is deemed present. Edge detections can occur at a predetermined interval such as, for example, the byte rate (⅛ of the data transmission rate). Edge detections can also be separated, grouped, and/or differentiated into predetermined groups.

In an example embodiment of the invention, edge detections can be grouped according to sample byte. As an example of grouping according to sample byte, consider data oversampled at block 202 with an oversampling ratio of five (N=5). If edges on the unarranged (serial) data are detected at block 203 at the byte rate, then there are a total 40 possible edge detections within the interval, i.e., for each eight incoming bits, the oversampled data is a 40-bit string, and each sample set is comprised of five consecutive samples per incoming bit. The 40 possible edge detections (because there are 40 adjacent bits) can then be grouped such that edges detected between the first and second samples of each sample set can be grouped together (into a total of eight possible detections, which correspond to a sample byte). Likewise, edges between the second and third samples of each sample set can be grouped together (into a total of eight possible detections, which correspond to another sample byte), and so forth. In this manner, edge detections can be correlated with each of the N sample bytes.

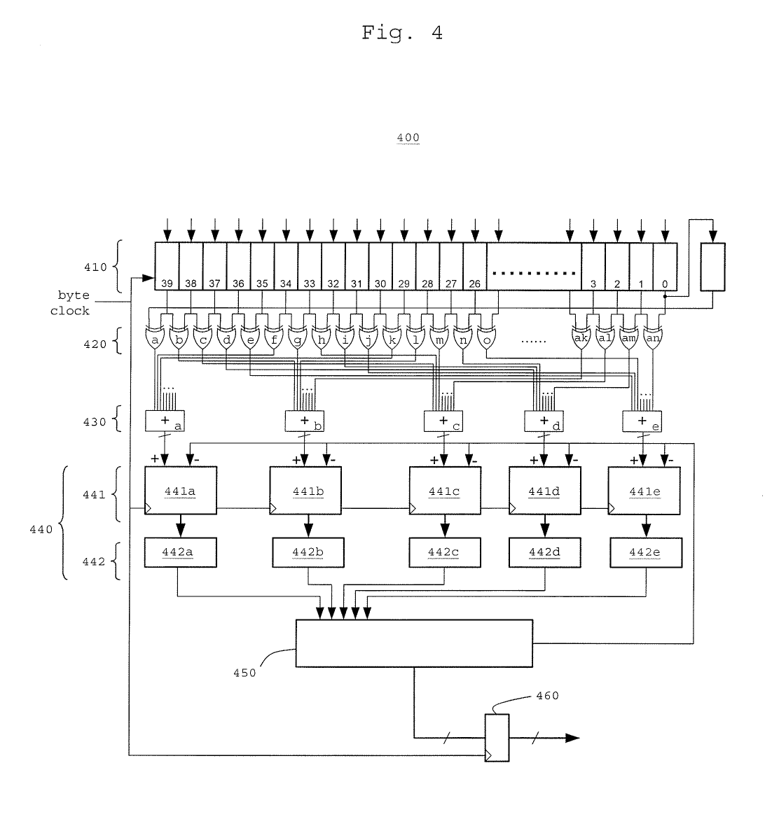

At block 204, the edges detected at block 203 are counted by a leaky counter, as described below in connection with FIGS. 4-7. In the example embodiment of the invention where the edge detections are grouped, each group of edge detections can be counted by one leaky counter.

At block 205, the output of the leaky counter(s) is used by a decision logic to select certain samples made at block 202 for output as recovered data. In the example embodiment of the invention where the oversampled data is arranged into N sample bytes, the samples selected at block 205 can correspond to one of the N sample bytes. The operation of a decision logic that can be used to perform the selection of samples of oversampled data is described below in connection with FIG. 4. At block 206, the method of FIG. 2 is terminated.

FIG. 3 shows a circuit diagram of an example CDR circuit 300 in accordance with an example aspect of the invention. CDR circuit 300 can be used for performing CDR on burst mode communications such as, for example, upstream GPON communications, and its operation can be preformed by (and it can be included in), for example, an OLT (or other network element) receiving upstream communications. Upstream data received by a device, such as an OLT, can be passed to the CDR circuit 300, which is comprised of deserializer 310, sampling point decider 320, demultiplexer 330, and byte aligner 340.

Deserializer 310 is comprised of oversampler 311, shift register 312, and buffer 313. Oversampler 311 oversamples the upstream data at a sampling rate equal to N multiplied by the data transmission rate (as described above in connection with FIG. 2). Shift register 312 converts oversampled data from a serial format to a parallel format. Parallel data output from shift register 312 has a bit width of, for example, N multiplied by 8 (“N×8”). Inputs to shift register 312 can include a serial data input, into which data such as, for example, oversampled upstream data can be input, and a clock input. The signal input to the clock input of shift register 312 (designated in FIG. 3 as “clock N×”) can be, for example, a clock having a frequency equal to the oversampling frequency of oversampler 311, i.e., N multiplied by the data transmission rate. Other clock signals can be input into shift register 312, including a half-rate clock (which can be used in conjunction with, for example, dual-edge sampling), multiple lower frequency phase-delayed clocks, and the like. Buffer 313 stores parallel format data received from shift register 312 and outputs the data (e.g., bytes in a parallel N×8 format) according a control signal received at its clock input. The control signal input to the clock input of buffer 313 (designated in FIG. 3 as “byte clock”) can be a clock having a frequency equal to, for example, the byte rate (⅛ of the data transmission bit rate) or any other suitable frequency. For example, if the upstream data rate is 1.244 Gb/s, the frequency of the byte clock can be 155.52 MHz. The byte clock can be obtained by manipulation and/or routing of a downstream clock, an ONT transmit clock, or any other clock associated with a network such as, for example, a PON.

The following is an example of the general manner in which deserializer circuit 310 operates. Consider an upstream communication over a GPON at a data transmission rate of 1.25 GB/s. If, for example, oversampler 311 is configured to oversample incoming data at a rate five times greater than the data transmission rate, then N=5 and the oversampling frequency of oversampler 311 is 6.25 GB/s. Given an input of one byte (8 bits) the output of oversampler 311 is a serial data stream of five bytes (40 bits) where the last five bits of the bitstream are samples 1-5 of the upstream data, the preceding five bits of the bitstream are samples 6-10 of the upstream data, and so forth. This serial bitstream is input to shift register 312, which, in the example of N=5, is a 5×8 shift register. Shift register 312 converts the serial bitstream to a parallel bitstream of 5×8 sampled bits, or 5 sampled bytes, such that samples 1-5 of the upstream data are the least significant bits (or “LSB”) of the 5 sampled bytes, samples 6-10 are the second LSB of the sampled bytes, and so forth. These 5 sampled bytes are inputted to buffer 313, which operates according to the above-described byte clock, and then can be further processed and/or manipulated by other elements or modules, such as, for example, sampling point decider 320, as described below in connection with FIGS. 4-7.

Although the preceding example has been described in the context of a deserializer circuit having N=5, this example was chosen only to illustrate an operative principle of deserializer circuit 310. The example should not be construed as a limitation on any other example embodiment of the invention, which can have different parameters.

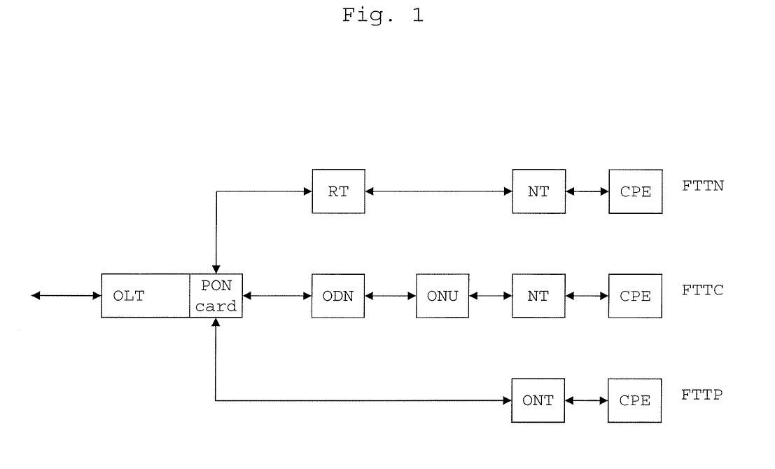

CDR circuit 300 can further operate as follows. Sampling point decider 320, an example circuit of which is described in further detail in connection with FIG. 4 below, selects from the multiple sampled bytes oversampled from upstream data by deserializer 310 a sample byte for output as recovered data. Demultiplexer 330 filters only the sampled byte selected by sampling point decider 320. Byte aligner 340 receives the selected sampled byte from demultiplexer 330 and outputs the byte as recovered data. Byte aligner 340 has a delimiter input, through which a byte pattern (e.g., in GPON, a 16-bit or a 20-bit byte pattern according to International Telecommunications Union (ITU) standards) can be passed. The byte pattern can be received from any suitable source such as, for example, a component, device, and/or circuit within an OLT or an ONT, or a source local to or comprising any of the elements of FIG. 1. Byte aligner 340 can use signals passing through the delimiter input to perform a shift in which the boundary of bytes of recovered data can be aligned to the byte boundary at the transmitting device. The timing of operations performed by sampling point decider 320, demultiplexer 330, and byte aligner 340 are controlled by a clock such as the byte clock described above; thus, the various elements of CDR circuit 300 can act in synchronicity.

FIG. 4 is an example circuit diagram of a sampling point decision circuit 400. Sampling point decision circuit 400 may be an example of a sampling point decider 320, and may be suitable for practicing one or more example embodiments of the invention. Consistent with the above-described example operation of deserializer 310 and for the sake of simplicity, sampling point decision circuit 400 is a specific illustration of a general sampling point decision circuit; in particular, circuit 400 illustrates a possible configuration when upstream data is oversampled at 5 times the data transmission rate, i.e., N=5. Upon review of the following description of circuit 400, those having skill in the art will be able to construct a sampling point decision circuit for values of N other than 5, and also will understand that other circuit combinations and configurations are possible.

Circuit 400 is comprised of input register 410, XOR gates 420, adders 430, leaky counters 440, decision logic 450, and decision buffer 460. A byte frequency clock (labeled as “byte clock” in FIG. 4, and described above in connection with FIG. 3) can be input into input register 410, leaky counters 440, and decision buffer 460. The byte frequency clock can be used to control the timing of incrementing, shifting, and/or other manipulating of data and/or signals in circuit 400.

Input register 410 can be configured to stores a 5×8 parallel input, such as the five parallel sampled bytes output from deserializer 310. (These five parallel sampled bytes correspond to the 40 samples of the eight upstream bits sampled by oversampler 311.) In an example embodiment of the invention, input register 410 stores the five parallel bytes according to their sample order. For example, the most significant bit (MSB) of the first byte is sent to slot 39, the MSB of the second byte is sent to slot 38, and so forth; the least significant bit (LSB) of the fifth byte is sent to slot 0. In accordance with an example embodiment of the invention, input register 410 is a 41-bit register, where the LSB of a preceding 5×8 parallel input is reserved by the register in an extra slot (as shown in FIG. 4). The reservation of a LSB of a preceding parallel input is described below in connection with the procedure performed by XOR gates 420.

XOR gates 420 can be configured in a manner suitable to determine where edges, i.e., transitions from “0” and “1” or vice versa, occur between adjacent bits in the serial data output from input register 410. As described above in connection with FIG. 2 and below in connection with the other components of circuit 400, edge detections can be used to select one sample byte from multiple sample bytes sampled by oversampler 311 of deserializer 310. Once selected, a sample byte can be output as recovered data by a CDR component or device such as, for example, byte aligner 340 of CDR circuit 300. In the example where N=5, there are 40 adjacent bits to compare for edge detection; thus, there are 40 XOR gates, labeled 420a through 420an.

XOR gates 420 are configured in a manner suitable for edge detection. Such configuration can be obtained by inputting into each of the 40 XOR gates a pair of two adjacent sampled bits. For instance, as illustrated in FIG. 4, sampled bits 39 and 38 are input to XOR gate 420b, sampled bits 38 and 39 are input to XOR gate 420c, and so forth through sampled bit 1, which is input with sampled bit 0 to XOR gate 420an. In order to detect all edges in the bitstream, the sampled bit preceding bit 39, i.e., sampled bit 0 (the LSB) of the previous 5×8 parallel input, is input with sampled bit 39 (the MSB of the current 5×8 parallel input) to XOR gate 420a. The LSB of the previous 5×8 parallel input is reserved between clock cycles in the slot shown in FIG. 4. In this manner, edges between each serially-sampled bit can be detected. By inputting adjacent bits in the manner described, each of the XOR gates 420 can output low (i.e., “0”) if there is no edge between the input bits (i.e., the adjacent bits have similar values) or high (i.e., “1”) if there is an edge between the input bits (i.e., the adjacent bits have dissimilar values). Therefore, XOR gates 420 perform five edge detections per upstream input bit, or 40 edge detections per upstream input byte.

The outputs from each of the XOR gates 420 can be grouped into one of five groups, where each group can correspond to one of the five sampled bits per upstream input bit. Because the oversampling ratio associated with circuit 400 is five, every fifth bit can be grouped together. For example, in sampling point decision circuit 400, the first group is comprised of XOR outputs (0*, 39), (35,34), (30,29), (25,24), (20,19), (15,14), (10,9), and (5,4), where the parenthetical numbered set indicates the sampled bits input to corresponding XOR gate 420 and “0*” indicates the LSB of the previous 5×8 parallel input, as described above. Similarly, the fifth (least significant) group is comprised of XOR outputs (36,35), (31,30), (26,25), (21,20), (16,15), (11,10), (6,5), and (1,0).

Each of the 5 groups formed from the 40 outputs of XOR gates 420 can comprise an input to one of adders 430. Thus, in the example of circuit 400 (N=5) there are five adders labeled 430a through 430e, each with input ports corresponding to the eight XOR outputs comprising the input group. Adders 430 are saturated, meaning that the signal output by any of adders 430 is constrained to equal to or less than a predetermined maximum value. Thus, the output of any of adders 430 can represents the number of edge detections represented by its respective input group of XOR outputs. As an example of the operation of adders 430 (and considering the first group of the example above), if XOR outputs (35,34), (20,19), and (10,9) represent edge detections (a high XOR output, e.g., “1”) and each of the other XOR outputs of the group do not represent an edge detection (a low XOR output, e.g. “0”), then adder 430b (the adder into which this group of XOR outputs is input) can output a signal corresponding to “3.” However, if “3” is above the maximum value of adder 430b (e.g., if the adder is saturated at “2”), then the adder can output the appropriate maximum representable number.

In another example embodiment of the invention, OR gates (not shown) can substitute for the saturated adders 430 shown in FIG. 4. Those having skill in the relevant arts will recognize in view of this description that within the context of circuits such as circuit 400, an OR gate can perform the same function as a saturated adder having a saturation value set to one. Furthermore, those having skill in the art will recognize in view of this description that if adders 430 are substituted with OR gates, other components of circuit 400 such as, for example, leaky counters 440 and/or decision logic 450 may require configurations other than those described herein with respect to these components.

The outputs of adders 430, which each represent the total number of edge detections made for one of the five sample bytes (within the operating boundaries associated with each adder) can control leaky counters 440. Circuit 400 is configured such that the output of each adder comprises an input to one leaky counter, e.g., adder 430a controls leaky counter 440a, and so forth. The outputs of adders 430, configured in the manner described, can increment leaky counters 440 (a procedure described below). Each leaky counter is comprised of one up/down counter (441a-e) and one zero comparator (442a-e). For example, leaky counter 440a is comprised of up/down counter 441a and zero comparator 442a.

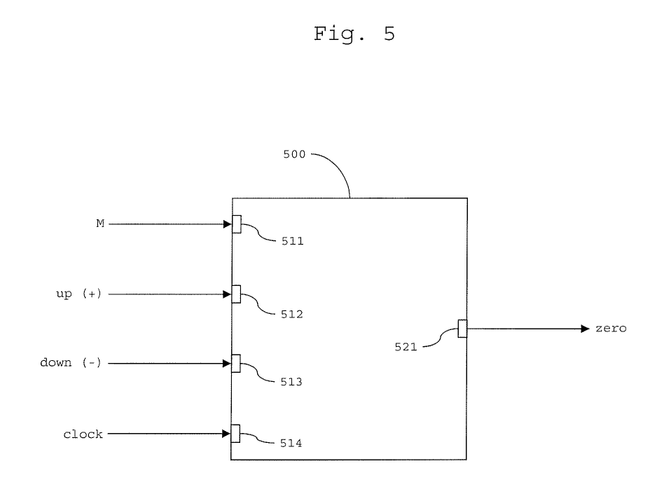

As described below in connection with FIGS. 5-7, and summarized now for clarity, each of leaky counters 440 is configured such that if an input group of a counter (corresponding to one of the five sampled bytes) detects one or more edges, the counter is incremented accordingly. Thus, a low count indicates few edges detected (e.g., aligned to an upstream transmission), while a high count indicates many edges detected (e.g., not aligned to an upstream transmission). If the upstream data is clean (e.g., little noise or jitter) then the CDR circuit can be locked to a sample group, and the counter corresponding to that group will remain zero, i.e., edges may not be detected by that group, and the counter will not be incremented over multiple clock cycles. If the upstream is not clean (e.g., noise, jitter, and new burst transmission), however, then even the group with the lowest count may detect one or more edges. Such a circumstance might occur if the upstream data bits drift with respect to the local OLT clock, e.g., clock N× described above. In this circumstance, the CDR circuit can adjust to lock on to an upstream transmission by selecting a different sample byte to output as the recovered data. In this manner, the output of leaky counters 440 can be used by decision logic 450 to select one of the five sample bytes for output as recovered data. Furthermore, if there is no zero output from any of leaky counters 440, a control signal output from decision logic 450 can be used to decrement all of leaky counters until a zero output counter is obtained.

Via a selecting logic, decision logic 450 can use the leaky counter outputs to select one of five sampled bytes output from deserializer 313. Selections made by decision logic 450 are passed to decision buffer 460, which can output, according to timing controlled by the byte clock (described above), the selected sample byte to byte aligner 340 of CDR circuit 300. In this manner, the CDR circuit 300 can output a sampled byte selected by decision sampling point circuit 400 as recovered data output.

Referring now to FIGS. 5-7, the operation of a leaky counter such as, for example, any of leaky counters 440 will now be described. FIG. 5 shows a diagram of an example leaky counter 500, which may be suitable for use in example embodiments of the invention. Input ports to leaky counter 500 can include a saturation port 511, an increment port 512, a decrement port 513, and a clock port 514; output ports can include zero comparator port 521. Leaky counter 500 can be sequentially comprised of an up/down counter (not shown) and a zero comparator (also not shown). Thus, the input ports, e.g., 511, 512, 513, and 514, can pass to the up/down counter, and the output ports, e.g., 521, can lead from the zero comparator.

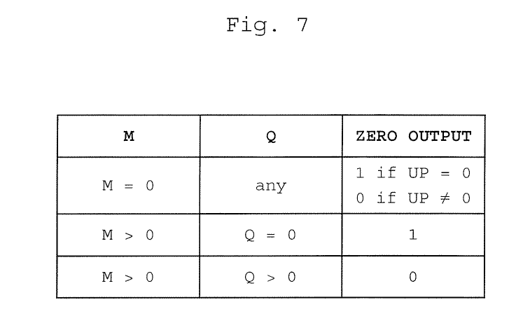

Signals received through saturation port 511 can be used to saturate the up/down counter of leaky counter 500. When saturated, the output of the up/down counter is constrained to values less than or equal to a maximum value, which is hereinafter referred to as “M.” M is a value that corresponds to a signal input into saturation port 511, thus the value of M can be changed by changing the signal level input through port 511. In some example embodiments of the invention, a leaky counter can have a value ranging from four to 64, although values of M outside of this range are possible in other example embodiments. The value of M need not be constant in time. In fact, in various example embodiments of the invention, the value of M can fluctuate and/or be variable, depending upon the desired operation and/or configuration of leaky counters such as, for example leaky counter 500 and leaky counters 440 shown in FIG. 4. Circumstances in which a variable value of M may be desired are described below in connection with FIG. 7.

Signals received through increment port 512 can be used to increment the up/down counter. One example of a signal which may be suitable for input to increment port 512 is the output of a saturated adder such as, for example, any of adders 430. When configured in the manner illustrated circuit 400, the output of a saturated adder (or an OR gate, as described above) can correspond to the number of edge detections made in a sampled byte, where the sampled byte can be one of multiple sampled bytes made by an oversampler such as oversampler 311. Thus, increments to the up/down counter, as made through increment port 512, will correspond to the number of edge detections in a sampled byte.

Signals received through decrement port 513 can be used to decrement the up/down counter. One example of a signal which may be suitable for input to increment port 512 is the output of a decision logic circuit such as, for example, the control signal output by decision logic 450.

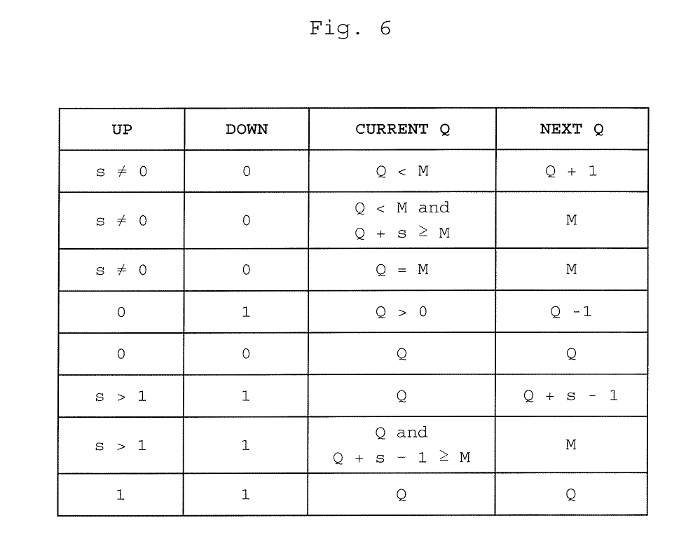

Signals received through clock port 514 can be used to control the timing of operations performed by the leaky counter, including, for example, calculations, data processing, and/or other data manipulations performed by the up/down counter, as described in connection with FIG. 6 below, and operations performed by the zero comparator, including output of signals through zero comparator port 521. A suitable clock for input through clock port 514 may include the byte clock described in connection with FIG. 3 above.

Signals output through zero comparator port 521 can correspond, relate, or otherwise be proportional to the result of calculations, data processing, and/or other data manipulations performed by the leaky counter such as, for example, operations associated with FIGS. 6 and 7 below.

FIG. 6 is a truth table which illustrates an example operation of leaky counter 500. The “UP” column corresponds to the signal received through increment port 512, e.g., “1” if there is one edge detection (as determined by, for example, a saturated adder), “2” if there are two edge detections, or “0” if there are no edge detections. The number of edge detections is indicated in FIG. 6 by “s.” The “DOWN” column corresponds to the signal received through decrement port 513, e.g., “0” if a decision logic has received a zero output at least one leaky counter or “1” if the decision logic has not received a zero output from any leaky counter. The column labeled “CURRENT Q” designates the output of the counter during the previous operation cycle, i.e., during the previous time count of the clock signal input through clock port 514. The value of Q previously output by the up/down counter can range from 0 to M. The “NEXT Q” column is the output of the up/down counter during the current clock cycle. Therefore, as shown in FIG. 6, the up/down counter can operate as follows. For each clock cycle in which one or more edges is detected by an XOR group (as described in connection with FIG. 3), the counter can be incremented. The counter will continue to increment with detections in subsequent cycles, up to a maximum count value of M, which is determined by the signal input through saturation port 511; once the counter reaches M, it will not increment any higher. Furthermore, the counter can be decremented by control signals received through decrement port 512. Example circumstances in which a control signal would decrement the up/down counter are herein described in connection with a decision logic and also described below in connection with FIG. 7.

In an example embodiment of the invention, the bit width of leaky counter 500 is four, i.e., the count output by the on/off counter is a 4-bit number. Thus, in this example embodiment, according to the truth table of FIG. 6, the maximum value of M for the on/off counter is 15.

FIG. 7 is a truth table which illustrates an example output of the zero port 521 of leaky counter 500. The output port can be the output of a zero comparator of a leaky counter. The column designated “M” represents the saturation value M of an up/down counter comprising the leaky counter. The “Q” column corresponds to the current output of the leaky counter such as, for example, the “NEXT Q” column of the table shown in FIG. 6. The column labeled “ZERO OUTPUT” is the output passed through the zero port 521. As described above in connection with FIGS. 4 and 5, the output of zero port 521 can be passed to a decision logic such as, for example, decision logic 450, which can use such outputs to select a sample byte from multiple sample bytes; an example of such a selection procedure is to perform logical operations on counts of edge detections.

A circumstance in which M can have a value of 0 can be, for example, if a burst of upstream data is beginning. In this circumstance, the sampling position, i.e., the selected sample byte, may need to be changed quickly, and a CDR circuit (and, more specifically, a sampling decision circuit) can quickly lock to an optimum sampled byte, as described above in connection with FIG. 4. Therefore, while M=0, zero port 521 will output “1” while the “UP” input to the leaky counter is nonzero (e.g., there are one or more edge detections from a saturated adder), and will output “0” while the “UP” input to the leaky counter is zero (e.g., there are no edge detections from a saturated adder); in effect, while M=0 the up/down counter is bypassed. If all up/down counters 441a-e input into a decision logic such as, for example, decision logic 450 are set to M=0, the decision logic can make rapid changes in a sampling position of oversampled data. In this manner, the detecting logic of a decision logic can operate on “0” outputs from leaky counters (e.g., leaky counters 440 and leaky counter 500) to quickly adjust to and/or lock onto an optimum sampling position.

Conversely, higher values of M can result in slower changes in a sampling position determined by a decision logic. A circumstance where M can be greater than 0 can occur, for example, if the CDR circuit has stably locked into a burst data transmission. In this circumstance, the zero port 521 of a leaky counter can output 1 while its counter value is 0, indicating that the leaky counter has counted no edge detections or otherwise is at a zero count. If the saturation value M is greater than 0 and the counter value also is greater than 0 (e.g., an edge has been detected by the counter's input), however, the zero port 521 will output 0, indicating that the leaky counter is not at a zero count. A decision logic such as, for example, decision logic 450 can operate to adjust the selected sample byte accordingly. If all leaky counters input to a decision logic are outputting nonzero values, however, the decision logic will not change the sampling position. Therefore, leaky counters such as leaky counter 500 can be used to improve the bit error performance and jitter tolerance of a CDR circuit recovering upstream data transmissions. Furthermore, a device which performs CDR in the manner described above in connection with FIGS. 5-7 can both tolerate jitter in data transmissions and quickly lock in to incoming burst mode communications. Such a result may be beneficial to devices in a network such as, for example, a PON (e.g., CDR circuit 300, sampling point decider 320, sampling point decision circuit 400, and/or one or more of the elements illustrated by FIG. 1) by allowing communications (e.g., upstream data transmissions) to be sent and received at higher data transmission rates.

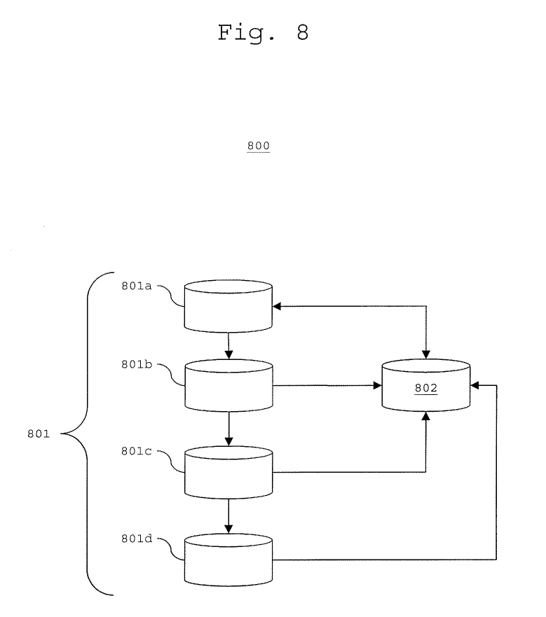

FIG. 8 illustrates a logical diagram 800 of modules such as, for example, application-specific integrated circuits (ASICs) or field-programmable gate arrays (FPGAs), which can be used in accordance with one or more example embodiments of the invention. The modules illustrated by diagram 800 can be used as or in association with the modules (e.g., deserializer 310, sampling point decider 320, demultiplexer 330, and byte aligner 340), circuits (e.g., CDR circuit 300 and sampling point decision circuit 400), and/or circuit elements (e.g., oversampler 311, shift register 312, buffer 313, input register 410, XOR gates 420, adders 430, leaky counters 440, decision logic 450, decision buffer 460) described herein.

Logical diagram 800 includes a CDR module 801 for performing CDR on digital data transmissions and a communication module 802 for directing information between sub-modules of CDR module 801, as well as receiving data (e.g., upstream data transmissions in a PON) from and sending data (e.g., recovered data) to other modules, circuit devices, and/or network elements.

The CDR module 801 includes: a sub-module 801a that oversamples a digital transmission (e.g., upstream data transmissions); a sub-module 801b arranged to detect edges between adjacent bits of oversampled digital transmission; a sub-module 801c that counts detected edges; and a sub-module 801d that selects samples of the oversampled digital transmission.

The communication module 802 can send digital transmissions to sub-module 801a for oversampling, and can receive oversampled data from sub-module 801a. The communication module 802 also can send oversampled data to sub-module 801b in order for sub-module 801b to detect edges in the data, and also can receive edge detections from sub-module 801b. The communication module 802 further can send edge detections to sub-module 801c for counting, and further can receive counts of edge detections from sub-module 801c. The communication module also can send counts of edge detections to sub-module 801d for the counts to be used by sub-module 801d in selecting one or more samples from the oversampled data, and also can received selections of oversampled data from the submodule 801d.

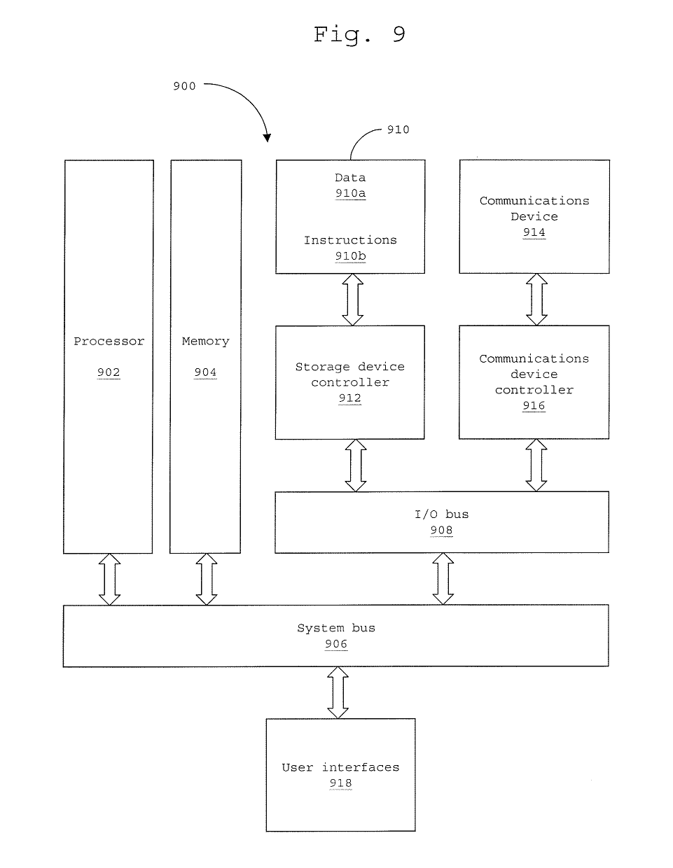

FIG. 9 is a diagram of an example data processing system which, according to various example embodiments, can form, be incorporated in, or be a part of, for example, any network element shown in FIG. 1 (e.g., an OLT and/or ONT). Data processing system 900 includes a processor 902 coupled to a memory 904 via a system bus 906. Processor 902 may be comprised of or contain one or more components of a CDR circuit such as, for example, CDR circuit 300 (not shown in FIG. 9) or, in other embodiments of the invention, the functionality of circuit 300 may be efftected using a computer program having program instructions 910b stored in a storage device 910. The processor 902 is also coupled to external devices (not shown) via the system bus 906 and an input/output (I/O) bus 908, and at least one user interface 918. The processor 902 may be further coupled to a communications device 914 via a communications device controller 916 coupled to the I/O bus 908. The processor 902 uses the communications device 914 to communicate with a network such as, for example, a PON, and the communications device 914 may have one or more I/O ports. Processor 902 also can include an internal clock (not shown in FIG. 9) to keep track of time and periodic time intervals. The user interface 918 may include, for example, at least one of a keyboard, mouse, trackball, touch screen, keypad, or any other suitable user-operable input device, and at least one of a video display, speaker, printer, or any other suitable output device enabling a user to receive outputted information.

A storage device 910 having a computer-readable medium is coupled to the processor 902 via a storage device controller 912, the I/O bus 908 and the system bus 906. The storage device 910 is used by the processor 902 and storage device controller 912 to read and write data 910a, and to store program instructions 910b. Alternately, program instructions 910b can be stored directly in non-volatile or volatile portions of memory 904. Program instructions 910b can be used to implement, for example, procedures described in connection with FIGS. 2-7.

The storage device 910 can also store various routines and operating systems, such as Microsoft Windows, UNIX, and LINUX, or the like, that can be used by the processor 902 for controlling the operation of system 900. At least one of the operating systems stored in storage device 910 can include the TCP/IP protocol stack for implementing a known method for connecting to the Internet or another network, and can also include web browser software for enabling a user of the system 900 to navigate or otherwise exchange information with the World Wide Web.

In operation, the processor 902 loads the program instructions 910b from the storage device 910 into the memory 904. The processor 902 then executes the loaded program instructions 910b to perform at least part of the example methods described herein.

By virtue of the example embodiments described herein, CDR with jitter tolerance can be performed on digital communications such as upstream data transmissions in FTTx networks. By tolerating jitter, CDR of digital communications can be performed at higher speeds, thus allowing communications to be transmitted at higher data bit rates.

In the foregoing description, example aspects of the present invention are described with reference to specific example embodiments. Despite these specific embodiments, many additional modifications and variations would be apparent to those skilled in the art. Thus, it is to be understood that example embodiments of the invention may be practiced in a manner otherwise than as specifically described. For example, although one or more example embodiments of the invention may have been described in the context of an oversampling ratio N equal to five, it should be understood that the invention is not so limited, and that in practice the example embodiments may include or incorporate any other type of content. Accordingly, the specification is to be regarded in an illustrative rather than restrictive fashion. It will be evident that modifications and changes may be made thereto without departing from the broader spirit and scope.

Similarly, it should be understood that the figures are presented solely for example purposes. The architecture of the example embodiments presented herein is sufficiently flexible and configurable such that it may be practiced (and navigated) in ways other than that shown in the accompanying figures.

Software embodiments of the example embodiments presented herein may be provided as a computer program product, or software, that may include an article of manufacture on a machine-accessible, machine-readable, or computer-readable medium having instructions. The instructions on the machine-accessible, machine-readable, or computer-readable medium may be used to program a computer system or other electronic device. The machine-readable or computer-readable medium may include, but is not limited to, floppy diskettes, optical disks, CD-ROMs, and magneto-optical disks or other type of media suitable for storing or transmitting electronic instructions. The techniques described herein are not limited to any particular software configuration. They may find applicability in any computing or processing environment. As used herein, the terms “machine-accessible medium,” “machine-readable medium,” or “computer readable medium” shall include any medium capable of storing, encoding, or transmitting an instruction or sequence of instructions for execution by the machine such that the machine performs any one or more of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

Furthermore, the purpose of the foregoing abstract is to enable the U.S. Patent and Trademark Office, the general public, and scientists, engineers, and practitioners in the art who are unfamiliar with patent or legal terms or phrases, to quickly determine from a cursory inspection the nature and essence of the technical disclosure of the application. The abstract is not intended to limit the scope of the present invention in any way. It is also to be understood that the processes recited in the claims need not be preformed in the order presented.

What is claimed is:

1. A method for performing clock phase and data recovery on a digital transmission, the method comprising:
oversampling the digital transmission into oversampled data;
detecting edges between adjacent bits of the oversampled data;
counting the edges; and
selecting at least one sample of the oversampled data,
wherein the at least one sample is selected by a decision logic and the decision logic is at least partially controlled by counts of the edges.

2. The method of claim 1, further comprising:
ordering the oversampled data into N sample bytes; and
correlating the edges with the N sample bytes,
wherein the at least one sample corresponds to at least one of the N sample bytes.

3. The method of claim 2, wherein the edges are counted by at least one leaky counter.

4. The method of claim 3, wherein the decision logic is at least partially controlled by the output of the at least one leaky counter and the at least one leaky counter is at least partially controlled by an output from the decision logic.

5. The method of claim 4, wherein the at least one leaky counter has a variable saturation value of M.

6. The method of claim 5, wherein M has a value ranging from 4 to 64.

7. The method of claim 2, wherein the digital transmission is an upstream communication in a PON.

8. The method of claim 7, wherein the upstream communication travels from an ONT to an OLT.

9. A communications system for performing clock phase and data recovery on a digital transmission, the communications system comprising:
at least two communicatively coupled network elements,
wherein at least one of the at least two network elements is arranged to oversample a digital transmission into oversampled data, detect edges between adjacent bits of the oversampled data, count the edges, and select at least one sample of the oversampled data, and wherein the at least one sample is selected by a decision logic and the decision logic is at least partially controlled by counts of the edges.

10. The communications system of claim 9, wherein the at least one of the at least two network elements is further arranged to order the oversampled data into N sample bytes and correlate the edges with the N sample bytes, and wherein the at least one sample corresponds to at least one of the N sample bytes.

11. The communications system of claim 10, wherein the edges are counted by at least one leaky counter.

12. The communications system of claim 11, wherein the decision logic is at least partially controlled by the output of the at least one leaky counter and the at least one leaky counter is at least partially controlled by an output from the decision logic.

13. The communications system of claim 12, wherein the at least one leaky counter has a variable saturation value of M.

14. The communications system of claim 13, wherein M has a value ranging from 4 to 64.

15. The communications system of claim 10, wherein the at least one of the at least two network elements is an OLT.

16. A network element operating in a communications network, the network element comprising:
a communications interface coupled to a network providing a plurality of communication services;
a storage device arranged to store program instructions; and
a processor coupled to the communications interface and the storage device, and operating under the control of the program instructions to communicate a digital transmission with the network through the communications interface,
wherein the processor operates under control of the program instructions to perform oversampling of the digital transmission into oversampled data, detecting of edges between adjacent bits of the oversampled data, counting of the edges, and selecting of at least one sample of the oversampled data, and wherein the at least one sample is selected at least partially based on counts of the edges.

17. The network element of claim 16, wherein the processor also operates under control of the program instructions to perform ordering of the oversampled data into N sample bytes and correlating the edges with the N sample bytes, and wherein the at least one sample corresponds to at least one of the N sample bytes.

18. The network element of claim 17, wherein the network element is an OLT.

19. A computer program embodied in a computer-readable storage medium, the program having instructions which, when executed by a computer, cause the computer to perform a method for performing clock phase and data recovery on digital transmission, the method comprising:
oversampling the digital transmission into oversampled data;
detecting edges between adjacent bits of the oversampled data;
counting the edges; and
selecting at least one sample of the oversampled data,
wherein the at least one sample is selected at least partially based on counts of the edges.

20. The computer program of claim 19, wherein the method further comprises:
ordering the oversampled data into N sample bytes; and
correlating the edges with the N sample bytes,
wherein the at least one sample corresponds to at least one of the N sample bytes.

21. An apparatus for performing clock phase and data recovery on digital transmission, the apparatus comprising:
an oversampler, arranged to oversample the digital transmission into oversampled data;
an edge detector, arranged to detect edges between adjacent bits of the oversampled data;
an edge counter, arranged to count the edges; and
a sample selector, arranged to select at least one sample of the oversampled data,
wherein the sample selector is at least partially controlled by an output of the edge counter.

22. The apparatus of claim 21 further comprising:
an ordering unit, arranged to order the oversampled data into N sample bytes; and
a correlating unit, arranged to correlate the edges with the N sample bytes,
wherein the at least one sample corresponds to at least one of the N sample bytes.

23. The apparatus of claim 22, wherein the edge counter is at least one leaky counter.

24. The apparatus of claim 23, wherein the at least one leaky counter is at least partially controlled by an output of the sample selector.

25. The apparatus of claim 24, wherein the at least one leaky counter has a variable saturation value of M.

26. The apparatus of claim 25, wherein M has a value ranging from 4 and 64.
